(19) United States
(12) Patent Application Publication
(10) Pub. No.: US 2025/0122372 A1
(43) Pub. Date: Apr. 17, 2025

(54) METHOD FOR PRODUCING BIODEGRADABLE STRETCH FILMS

(71) Applicants: BIOWRAP, Servon (FR); GREEN BUSINESS AND CONSULTING COMPANY, Cournon-d Auvergne (FR)

(72) Inventor: Laurent MASSACRIER, Cournon-d Auvergne (FR)

(73) Assignees: BIOWRAP, Servon (FR); GREEN BUSINESS AND CONSULTING COMPANY, Cournon-d Auvergne (FR)

(21) Appl. No.: 18/688,384

(22) PCT Filed: Aug. 31, 2022
(86) PCT No.: PCT/EP2022/074197

§ 371 Date: Mar. 1, 2024

(30) Foreign Application Priority Data
Sep. 1, 2021 (FR) FR2109157

(51) Int. Cl. C08L 67/02; C08J 5/18

(52) U.S. Cl. CPC C08L 67/02; C08J 5/18; C08J 2367/02; C08L 2201/06; C08L 2203/16

(57) ABSTRACT

The invention relates to a plastic film, containing a layer comprising an aliphatic copolyester and/or an aliphatic-aromatic copolyester and between 1 and 20% (by weight) of a polyadipate consisting of a polyester of adipic acid with a diol or a mixture of C3-C4 diols, as well as to their manufacturing processes and uses.

The invention relates to the field of manufacturing a biodegradable or compostable plastic film.

The innovation is particularly relevant to the industrial palletizing and food packaging film market, where the film's sliding force is a key functional parameter.

The films described can also be used in the agricultural field as wrapping films (especially for forage) or silage films, to package and protect agricultural products (forage, hay bales, etc.).

It is remembered that a plastic material or, in everyday language, a plastic, is a mixture containing a base material (a polymer or a mixture of polymers) which can be molded or shaped, usually under heat and pressure, to produce a semi-finished product or object. In the present case, the monomers and polymers used to produce the films and the additives (elements added to these monomers and polymers) can be biodegraded or composted, this property being thus extended to the films.

In particular, the film described here is stretchable and industrially compostable, and offers high performance:
On the aspect of adhesion: this is the “cling” effect, characterized by peel strength (measured according to ASTM D-5458) and lap strength (measured according to ASTM D-1894).
On mechanical properties, in particular elongation at break, measured according to ISO 527.
On biodegradation performance.

The SUP (Single Use Plastic) Directive calls for a total ban on single-use plastics by 2040, and the regulation intends to encourage the replacement of these plastics with alternative materials that have an operational recycling chain and reduce their environmental impact, including on biodiversity, assessed by means of a comparative life-cycle analysis in relation to the impact of the single-use plastic packaging that these alternatives replace.

Moreover, bio-waste management will become increasingly important over the next few years, with the aim of organically recovering biological waste, particularly through industrial composting, for both industrial and private customers.

Bioplastics, compostable materials derived from plant-based products, make it possible to:
Preserve biodiversity, for example by enabling the rapid return of carbon to the soil, as suggested by the COP21 4/1000 initiative.
Limiting the use of fossil resources, as being mostly made of plant carbon, which is renewed each year at the rhythm of the harvests,
Be inherently biodegradable, thus avoiding long-term pollution of seas and oceans.

It is therefore interesting to develop bioplastic alternatives to the films currently used for pallets and silage: these films must be stretchable, but also “sticky” or adhesive, i.e. the film must be able to adhere to itself during application (on pallets or silage bales).

The stretch film market is worth more than 15 MT/year, with cast extrusion (70%) and blown extrusion (30%) technologies. These films can be multilayer (75%) or monolayer (25%), and there are 3 main markets:
Agricultural silage and wrapping films (thickness generally between 20 and 80 μm), where a balance between Peel and Lap is important. One can mention films for bale wrapping or silage tarpaulin films (for covering fodder piles); these films preferentially have anti-UV properties.
Industrial palletizing films (thickness generally between 15 and 40 μm)
Food-grade films (thicknesses generally between 5 and 15 μm); sliding force is the most important characteristic for the latter two applications.

Traditional stretch films are made from 2 families of polymers:
Polyethylene (PE)-based films, especially for the agricultural market and industrial palletizing
Polyvinyl chloride (PVC)-based films, widely used in food packaging, particularly in very thin thicknesses (between 5 and 9 μm).

Polyethylene (PE)-based films are mainly based on linear low-density polyethylene (LLDPE) or metallocene polyethylene (mPE), the former offering higher tensile strength. PIB (PolylsoButylene) must generally be added to achieve the required adhesion strength (“cling” effect).

In terms of functionality, for films produced by extrusion blow-molding, the following can be noted:
PIB additivation rate between 4 and 10%.
Tensile strength: approx. 30 MPa for a blowing rate (BR) of 2
Young's modulus: between 120 and 200 MPa (machine direction (SM) and transverse direction (ST))
Peel strength: between 6 and 10 N/m at 25° C. for 6% PIB
Lap strength: approx. 6 N/25 mm at 5% PIB

These values are particularly suitable for industrial films.

However, neither the polymer (PE) nor the PIB additive is biodegradable or compostable.

PVC-based stretch films require the addition of additives chosen in particular from 2 main families:
“Phthalates”, such as DOTP (or DEHT-[(bis(2-ethylhexyl) terephthalate]), e.g. the commercial products Palatinol® (BASF) or Adoflex® (GrupaAzoty)
“Adipates” such as DEHA ([di-2-ethyl hexyladipate]), with products such as Adimoll® (Lanxess) or Plastomoll® (BASF).

They are incorporated in large quantities, alone or in mixtures. In general, “phthalate” additives make it possible to obtain much higher functional performance than “adipate” (DEHA) additives.

There is a class of biodegradable polyesters whose mechanical properties are a priori suitable for the production of stretch films: these are PBATs (Poly Butylene co-Adipate-co-Terephthalate, a copolyester of adipic acid, 1,4-butanediol and terephthalic acid). This is copolyesterstatistics, as there is no control over polymer chain length dispersion or block structuring in copolymerization reactions, nor selectivity for the polyesters to react with themselves or with each other during preparation.

Commercial PBATs include BASF's EcoFlex® F Blend C1200 and Kingfa's KD1024. These materials can also be biosourced, like Kingfa's product (reference KD1023), containing around 38% plant carbon.

For these materials, the following notable performances can be noted for 50 μm films:
Elongation at break: between 500 and 800%.
Young's modulus: around 100 MPa

Unfortunately, their “cling” properties are not sufficient for use in stretch film (industrial or food). Below are comparative values for lap strength between Ecoflex® F Blend C1200 and non-biodegradable commercial stretch films:
Ecoflex® F Blend C1200: 2.2 N/25 mm (film on film); 1.1 N/25 mm (film on steel)
PVC film: 4.1 N/25 mm (film on film); 1.7 N/25 mm (film on steel)
PE film (90% LLDPE+10% PIB): 5.3 N/25 mm (film on film)

Gan et al (Polymer Degradation and Stability 87 (1): 191-199) describe the preparation of poly(butylene) adipate films.

JP2014005435 describes a resin based on polylactic acid, biodegradable aromatic aliphatic polyester and adipic acid ester plasticizer.

The present application is based on the addition of a polyadipate consisting of an adipic acid polyester with a C3-C4 diol or mixture of diols (in particular an adipic acid polyester with 1,3-butanediol, 1,2-propanediol and optionally also 2-ethyl-1-hexanol, CAS Number: 73018-26-5) to an aliphatic copolyester and/or an aliphatic-aromatic copolyester (i.e. a mixture of at least one aliphatic copolyester and at least one aliphatic-aromatic copolyester). Generally, however, the polyadipate is blended with only one type of copolyester, and even with only one copolyester. This additive (which may be referred to as “polyadipate” in the present application) makes it possible to
increase the “cling” properties of films for their use in biodegradable stretch films, in particular by increasing lap strength, an effect observed when the polyadipate is present between 1 and 20% (limits included) w/w (weight on weight) in the layer
act as a plasticizer for these copolyesters (lowering Tg, glass transition temperature measurable by DSC)
improve or maintain biodegradability, notably by reducing hydrophobicity: the polyadipate can increase polymer biodegradation kinetics by reducing polymer hydrophobicity.

The invention thus relates to a plastic film, characterized in that it contains a layer containing an aliphatic copolyester and/or an aliphatic-aromatic copolyester and between 1 and 20% (by weight) of a polyadipate consisting of a polyester of adipic acid with a diol or a mixture of C3-C4 diols. The term “a polyadipate consisting of a polyester of adipic acid with a diol or a mixture of C3-C4 diols” refers to the use of a single polyadipate or a mixture of polyadipates. Thus, in a particular embodiment, a single polyadipate consisting of a polyester of adipic acid with a diol or a mixture of C3-C4 diols is used. In another embodiment, a mixture of polyadipates consisting of an adipic acid polyester with a diol or a mixture of C3-C4 diols is used.

As shown in the examples, this film can be biodegradable or compostable, particularly when the aliphatic copolyester and/or aliphatic-aromatic copolyester is 10 compostable or biodegradable. It is also stretchable (“cling” effect), and also has adhesive properties. Furthermore, the examples show that polyadipate can be considered to act as a plasticizer for aliphatic copolyester and/or aliphatic-aromatic copolyester.

In the context of the present invention, the term “biodegradable” refers to any biological, physical and/or chemical degradation of substances at the molecular level by the action of environmental factors (in particular enzymes derived from the metabolic processes of microorganisms). Numerous definitions of biodegradation have been adopted (ISO 472-1998, ASTM subcommittee D20-96, DIN 103.2-1993), depending on the standards organization, the biodegradability measurement technique, and the degradation medium. However, a consensus has emerged that biodegradation can be defined as the decomposition of organic matter into carbon dioxide, water, biomass and/or methane under the action of micro-organisms (bacteria, enzymes, fungi).

One example is EN 13432, which defines the requirements for packaging that can be valorized by composting and biodegradation. The evaluation criteria set out in this standard are as follows:
the material tested must contain a minimum of 50% volatile solids
the concentration of toxic and hazardous substances identified in the standard (Zn, Cu, Ni, Cd, Pb, Hg, Cr, Mo, Se, As, Fe) must be below the threshold specified in the standard.
biodegradability must be determined for each packaging material or each significant organic constituent of the packaging material, where significant means any organic constituent representing more than 1% of the dry mass of that material
the total proportion of organic constituents whose biodegradability is not determined must not exceed 5%.
each test material must be inherently and ultimately biodegradable as demonstrated by laboratory tests (identical to ISO 14851:1999 and 14852:1999) and must comply with the following criteria and acceptance levels: in an aerobic environment, the percentage biodegradation of the test material must be equal to at least 90% in total, or 90% of the maximum degradation of an appropriate reference substance once a plateau has been reached for both the test material and the reference substance (e.g. cellulose). The duration of the test should not exceed 6 months.
each material tested must disintegrate during a biological waste treatment process: after a composting process lasting no more than 12 weeks, a maximum of 10% of the initial dry mass of the material tested may be rejected for a mesh size of 2 mm.
the final compost must meet European or, failing that, national compost quality requirements.

Thus, for the purposes of this invention, a biodegradable or compostable material is taken to mean a material that decomposes as defined above.

The polyadipate used is obtained by esterification of adipic acid and a C3-C4 diol or a mixture of C3-C4 diols.

It is reminded that the formula for adipic acid is

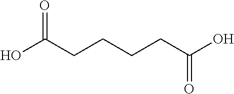

A C3-C4 diol is a molecule containing 3 or 4 carbon atoms and 2 alcohol functions. A saturated diol (without double bonds) is preferred, so that the esterification product is also saturated. Examples include propane 1,2-diol, propane 1,3-diol, butane 1,2-diol, butane 1,3-diol or butane 1,4-diol. These compounds are preferred in the preparation of the polyadipate used in the implementation of the invention. 1,3-butanediol, 1,2-propanediol and mixtures thereof are particularly suitable.

The esterification reaction produces an ester functional group R1-COO—R2, obtained by condensation of a carboxylic acid group R1-COOH (carried by adipic acid) and an alcohol group R2-OH (carried by the C3-C4 diol or mixture of diols).

It is also possible to add another main-chain C1-C10 alcohol (including limits), preferably C3-C6, to the esterification reaction. In particular, 2-ethyl-1-hexanol can be used in this esterification reaction. In this way, the diol or mixture of diols can contain other molecules carrying alcohol functions. They are present at no more than 25%, preferably at no more than 20% by weight, based on the C3-C4 diol or diol mixture.

In a preferred embodiment, the viscosity of the polyadipate is between 800 and 1200 cPoises at 25° C., preferably around (+/−5%) 1000 cPoises.

In a preferred embodiment, the polyadipate has a molar mass of less than 5000 g/mol.

Thus, in one particular embodiment, the polyadipate used was obtained by esterification of adipic acid with a mixture of 1,3-butanediol, 1,2-propanediol and 2-ethyl-1-hexanol.

In a preferred embodiment, the aliphatic copolyester and/or aliphatic-aromatic copolyester is of high molecular weight, its molecular weight being in particular greater than or equal to 30,000 g/mol, preferably greater than or equal to 50,000 g/mol. Preferably, the aliphatic copolyester and/or aliphatic-aromatic copolyester is formed by esterification of one or more C3 or C4 diols (in particular butane 1,4-diol), and one or more diacids having 5 or more carbon atoms between the two acid functions (in particular adipic acid). Several diacids, including adipic acid, are preferred for the esterification reaction.

One can cite, as aliphatic-aromatic copolyester, the copolyesters obtained from one or more C3 or C4 diols, a diacid with an aromatic ring, and an aliphatic diacid with at least 5 (or at least 6) carbon atoms between the two acid functions (in particular adipic acid (C6), but also azelaic acid (C9), sebacic acid (C10) or brassilic acid (C13)). Preferably, these diacids have no side chains and are unbranched. Aromatic diacids include terephthalic acid, but also diacids comprising aromatic heterocycles, such as 2,5-furandicarboxylic acid (FDCA). As diol, butanediol or propanediol can be used. Butanediol (in particular butane 1,4-diol) is of particular interest. However, one can also advantageously envisage the use of propane 1,3-diol.

In a particular embodiment, PBAT is used as an aliphatic-aromatic copolyester. PBAT (polybutylene terephthalate-co-adipate) is a copolyester prepared by polycondensation of 1,4-butanediol (or butane 1,4-diol) and a mixture of adipic acid and terephthalic acid. Methods for preparing PBAT are known to the skilled person. One method involves making a polyester from adipic acid and butane 1,4-diol, and a polyester from dimethyl terephthalate (rather than terephthalic acid) and butane 1,4-diol, followed by transesterification by reacting these two polyesters.

Terephthalic acid can be produced by catalytic oxidation of p-xylene, which can be of fossil or biobased origin. Butane 1,4-diol and adipic acid can be obtained by fermentation from glucose or sucrose. Thus, in this embodiment, the layer contains PBAT. Generally, at least 50% molar of the diol is used, with the diacid ratios varying, although, in general, the amount of terephthalic acid does not exceed 20% molar and is preferably between 15% and 18%.

In a particular embodiment, PBSA is used as an aliphatic copolyester. It is reminded that PBSA is poly(butylene succinate-co-adipate), and that it is prepared by polycondensation (esterification) of 1,4-butanediol and a mixture of adipic acid and succinic acid. These three constituents can be produced from renewable raw materials such as glucose and sucrose by fermentation, or from petroleum origin. Alternatively, aliphatic copolyesters can be obtained from one or more C3 or C4 diols, succinic acid, and an aliphatic diacid with at least 5 (or at least 6) carbon atoms between the two acid functions (in particular adipic acid (C6), but also azelaic acid (C9), sebacic acid (C10) or brassilic acid (C13)). Preferably, these diacids carry no side chains and are unbranched. Butanediol or propanediol can be used as the diol. Butanediol (in particular butane 1,4-diol) is of particular interest. However, the use of propane 1,3-diol is also advantageous.

In general, the film layer contains between 1% and 20% (including limits) of the polyadipate as described above. It has in fact been shown that the technical effect (cling effect and elongation) is observed as soon as 1% of the polyadipate is added to the layer. However, the amount of polyadipate should not exceed 20%. Preferably, the layer contains between 5 and 12% of the polyadipate described above, generally between 7% and 10%.

The use of a polyadipate, as described above, with an aliphatic or aromatic-aliphatic copolymer results in an adhesive film (cling effect). As a result, the film preferably has a sliding force (film/film, N/25 mm) greater than or equal to 3.

In a particular embodiment, the Young's modulus of the film is greater than or equal to 80 MPa. Preferably, the Young's modulus is less than 250 MPa, more preferably less than 150 MPa.

In a particular embodiment, the elongation at break of the film, particularly in the extrusion direction, is greater than or equal to 400%, preferably greater than or equal to 500%.

The plastic film may also contain one or more other components, in the layer comprising the polyadipate or in another layer (in the case of a multi-layer film), in particular chosen from anti-UV agents, anti-oxidizing agents, brightening agents (in particular to absorb ultraviolet electromagnetic radiation between 300 and 400 nm wavelength), an additive that retards photodegradation (such as carbon black) and an anti-fogging product. When film polymers are biodegradable or compostable, it is preferable to choose another component that degrades rapidly in nature. In particular, UV-absorbing agents are of particular interest for films used in connection with silage. These other components are generally present in quantities of between 0.1 and 3% (by weight), the total of these components not exceeding 10% by weight. In particular, UV stabilizers (0.1 and 3%), antioxidants (0.1 and 3%), brighteners (to prevent yellowing, between 1 and 5%), and possibly anti-fog products (for agricultural films) can be added.

In general, the film thickness is between 5 μm and 80 μm. As seen above, for industrial stretch films, the thickness is preferably between 15 and 40 μm; for food stretch films, the thickness is generally between 5 and 15 μm; for silage films, the thickness is notably between 20 and 80 μm.

In one embodiment, the plastic film is monolayer. It therefore consists of the layer comprising the polyadipate and the aliphatic polymer and/or aliphatic-aromatic polymer, optionally with the addition of another component as listed above. Single-layer films are particularly interesting for food applications.

In another embodiment, the plastic film is a multi-layer film (usually bilayer or trilayer). In this embodiment, the layer containing aliphatic copolyester and/or aliphatic-aromatic copolyester and polyadipate is an outer layer. In the case of a bilayer film, the second layer may contain PBAT, or PBSA or any other suitable (preferably biodegradable) polymer. This second layer may also contain additives, as mentioned above, as well as organic or inorganic (mineral) colorants or fillers.

In the case of a three-layer film, a non-tacky side (layer) based on PBAT alone or with an inorganic filler (possibly lamellar, such as talc, mica or kaolin) to facilitate opening, a central layer of PBAT alone, and another side (layer) with the formulation of the invention to provide a good tack.

Preferably, the thickness of the layer according to the invention is ⅓ of the total film thickness.

Industrial films can be two-layer or three-layer (with a tacky outer layer). For use as silage film, the elements packaged by the film are wished to be protected from UV: a layer with a lot of anti-UV agents can therefore be used, and anti-fogging agents are added to the sticky layer (the layer containing the polyadipate, as described above).

Inorganic fillers (possibly lamellar) can also be added to the non-stick layer.

Processes for producing multilayer films are well known to those skilled in the art. In particular, different polymers are extruded and superimposed on the annular die before flattening (casting) or inflating.

In a preferred embodiment, the film is obtained by extrusion blow-molding. This process is well known to those skilled in the art. The granules (compound) enter a heated tube fitted with one or more screws. The homogenized soft material is pushed, compressed and then passed through a die (spineneret). The polymer thus formed is then expanded with compressed air at the extruder/die outlet. In this way, the extruder outlet is vertical, and compressed air is blown into the melt, which swells and rises vertically into a long film bubble. The inflation ratio can be defined as the ratio between the circumference of the sheath (of the film) and that of the die. Generally speaking, the inflation ratio is between 1.5 and 3.5. In implementing the invention, inflation ratios of between 2 and 3 are preferred. After cooling, rollers flatten the film into a flat sheath, which is then cooled and wound onto reels. This method is used in particular to obtain films used in the manufacture of packaging, garbage can liners, freezer bags, medical infusion bags and thin flexible sheets for horticultural greenhouse liners.

In another embodiment, the film is obtained by cast film extrusion. In this method, the polymer falls onto a thermostatically-controlled cooling roller at the die exit. The cold enables recrystallization, and the speed of rotation of the rollers enables thickness adjustment. The film is then wound onto reels.

One can therefore define a machine direction, or long direction, or extrusion direction as the direction in which the film is wound onto the reels. The traverse or perpendicular direction is the direction perpendicular to the long direction (and therefore parallel to the axis of the reels on which the film is wound).

The invention also relates to a process for manufacturing a plastic film as described above, comprising
a) the mixture, in an extruder (preferably twin-screw),
   i. an aliphatic copolyester and/or an aliphatic-aromatic copolyester,
   ii. of a polyadipate consisting of a polyester of adipic acid with a C3-C4 diol or diol mixture, the amount of polyadipate being between 1 and 20% (by weight),
   iii. and optionally at least one other component selected from UV stabilizers, colorants, antioxidants, brighteners, photodegradation retardants and anti-fog agents.
      to obtain mixed material (also named compound), and
b) film formation from the mixed material by extrusion blow-molding or flat extrusion.

This process can also include, in step b), the addition of other compound elements to form multilayer films, as seen above.

The invention also relates to the use of a film as described above for pallet wrapping, food packaging or as an agricultural silage film or silage tarpaulin. These films are used in methods for pallet wrapping, food packaging or silage wrapping. When used for pallet wrapping or silage, products are generally wrapped in such a way that a non-stick layer is on the outside (to prevent pallets from sticking together and/or from tearing the film during handling).

The invention also relates to the use of an adipic acid polyester with a C3-C4 diol or diol mixture (as described above) for the preparation of a plastic film. Similarly, the invention relates to the combined use of an aliphatic copolyester and/or a biodegradable aliphatic-aromatic copolyester and an adipic acid polyester with a diol or a mixture of C3-C4 diols for the preparation of a plastic film. This film is in particular stretchable, has adhesive properties and/or is biodegradable or compostable.

The invention also relates to a process for preparing a material usable to manufacture a film (preferably biodegradable or compostable) comprising the mixture, in an extruder (preferably twin-screw),
i. an aliphatic copolyester and/or an aliphatic-aromatic copolyester,
ii. of a polyadipate consisting of a polyester of adipic acid with a C3-C4 diol or diol mixture, the amount of polyadipate being between 1 and 20% (by weight),
iii. and optionally at least one other component selected from UV stabilizers, colorants, antioxidants, brighteners, photodegradation retardants and anti-fog agents.

This material is called a “compound”. This material, which is susceptible to be obtained by the above process or is obtained by the above process, is also an object of the invention. It generally takes the form of granules (the extrudate is cooled and cut at the extruder exit), the composition of which is defined according to the products introduced into the extruder, as described above.

The invention also relates to a process for making a film as described above, comprising extruding such a compound (to melt it), and forming the film from the melted compound by extrusion blow-molding or flat extrusion.

### FIGURES

FIG. 1: FTIR spectra of Ecoflex F C1200 (black) and Compound D (green)

FIG. 2: FTIR spectra of MaterBi CX01A (red) and compound D (green)

FIG. 3: FTIR spectra of PBS FD92 (polybutylene co-adipate co-succinate) (black) and compound D (orange)

FIG. 4: mineralization tests to determine biodegradability potential.

### EXAMPLES

### Example 1. Implementation of Formulations and Stretch Films

Tests were carried out on different additives in a comparative manner, and also with a commercial reference material for the production of biodegradable stretch film (trademark Mater-bi CX 01A manufactured by Novamont, Novara, Italy). The main additives and polymers used are listed below:

TABLE 1

| Name | Supplier | Description |
|---|---|---|
| Ecoflex F Blend | BASF | Biodegradable PBAT copolyester |
| C1200 | | |
| PW70 | Polytechs | Masterbatch 70% PIB with PE base |
| ES01 | Polytechs | Masterbatch 30% PIB with PBAT base |
| Glyplast 206 | Condensia | Polyadipate (adipic acid with 1,3- |
| | | butanediol, 1,2-propanediol and 2-ethyl- |
| | | 1-hexanol) |
| MaterBi CX01A | Novamont | Compound for biodegradable stretch film |
| | | grade |
| Adimoll | Lanxess | DEHA |
| PBS FD92 | PTT MCC | Copolyester PolyButylene-Succinate- |
| | | Adipate (PBSA) |
| PBS FZ91 | PTT MCC | Polybutylene succinate polymer (PBS) |

The table below shows the compositions of some compounds produced within the scope of the invention and their processing conditions by twin-screw extrusion:

TABLE 2

| | | Extrusion |
|---|---|---|
| Test | Formulation composition | temperature (° C.) |
| Compound A | Ecoflex F Blend C1200 + 3% | 80/110/135/150 × 8 |
| | PW70 (weight on weight) | |
| Compound B | Ecoflex F Blend C1200 + 15% | 80/110/135/150 × 8 |
| | ES01 (weight on weight) | |
| Compound C | Ecoflex F Blend C1200 + 8% | 80/110/135/150 × 8 |
| | Adimoll (weight on weight) | |
| Compound D | Ecoflex F Blend C1200 + 8% | 80/110/135/150 × 8 |
| | Glyplast 206 (weight on weight) | |
| Compound E | PBS FD92 + 8% Glyplast 206 | 50/75/115/130 × 8 |
| | (weight on weight) | |
| Compound F | PBS FZ91 + 8% Glyplast 206 | 80/110/135/150 × 8 |
| | (weight on weight) | |

The tests were carried out on a twin-screw corotating extruder, the main characteristics of which are given below:
Screw diameter: 30 mm
L/D ratio: 52
Max. speed: 600 rpm
Motor power: 11 kW
Max. current: 21.5 Amp
Spinneret 1 ring diameter 4 mm

The polymer is introduced in the main feed and the liquid additives are injected a little further (between 4 and 8D (D being the screw diameter), i.e. 1 to 2 modules after the main feed zone). The degassing well is left open to the atmosphere, without forced degassing. It should be noted that twin-screw extrusion is a process known to those skilled in the art. The extrusion machine is more particularly of the interpenetrating co-rotating twin-screw type, and comprises two driven screws of length L and diameter D, rotating around their axes through a motor and a gearbox, inside an elongated envelope forming a sheath, surrounded by heating elements. These screws are fitted with helical threads, or modular screw elements, which mesh with one another. Some of these modular elements transform the linear flow (transport/conveying by double-threaded modular elements) into a radial flow (single-lobe or twin-lobe mixers).

At the end of the die, the rush is cooled in a water tank; cutting is deferred via a pelletizer; the pellets are not steamed and, after cooling, are packed in PE bags.

Machine parameters are monitored via SME (Specific Mechanical Energy), a particularly important parameter in twin-screw extrusion. With equivalent thermal energy, it reflects the energy consumed by the product during its transformation, and is directly proportional to viscosity. It is calculated according to:

$$SME = \frac{P \times V \times I}{Im \times Vm \times Q} \\ SME = ( P \times V \times I ) / ( Im \times Vm \times Q )$$

In which
P: motor power in W
I and Im: current consumed and Maximum Current in Ampere
V and Vm: Screw speed and Maximum screw speed in rpm
Q: mass flow rate in kg/h

In the context of the above tests, screw speeds and flow rates are set to give a virtually identical SME for all products, i.e. around 300 W·h/kg.

Compounds and reference materials are then extruded by extrusion blow-molding on a Tecnocanto single-layer machine with a blow-up ratio (TG) close to 2 (ratio of the sheath diameter to the die diameter, and corresponds to the transverse deformation of the material).
Screw diameter: 20 mm; L/D=25
20 mm die; 0.8 mm air gap; no filter.
2 heating zones on the screw; 1 zone on the die; 1 zone on the head
Max. width: 200 mm

Film properties measured in the machine direction (SM) are given in the following table:

TABLE 3

| | | | | Sliding | |
|---|---|---|---|---|---|
| | | | Elongation | force | |
| | Thickness | Modulus | at break | film / film | |
| Film | (μm) | (MPa) | (%) | (N/25 mm) | Remarks |
| Eco | 19 | 92 | 730 | 2.24 | Very good |
| C1200 | | | | | Extrusion |
| Comp. A | 27 | — | — | — | Material |
| | | | | | incompat- |
| | | | | | ibility |
| Comp. B | 21 | 125 | 605 | 1.94 | Sliding |
| | | | | | effect |
| Comp. C | 24 | 60 | 575 | — | Sheath |
| | | | | | instability |
| | | | | | gels on |
| | | | | | surface |
| Comp. D | 21 | 85 | 745 | 4.62 | Very good |
| | | | | | Extrusion |
| PBS | 22 | 248 | 380 | 0.45 | Very good |
| FD92 | | | | | Extrusion |
| Comp. E | 24 | 225 | 415 | 1.19 | Very good |
| | | | | | Extrusion |
| PBS | 20 | 445 | 210 | 0.32 | Very good |
| FZ91 | | | | | Extrusion |
| Comp. F | 18 | 431 | 223 | 0.38 | Very good |
| | | | | | Extrusion |
| MB | 18 | 96 | 665 | 2.72 | Very good |
| CX01A | | | | | Extrusion |

These results lead to the following conclusions:
DEHA (bis(2-ethylhexyl) adipate; CAS 103-23-1) and PIB (polyisobutene) do not appear to be compatible with PBAT (compounds C, A and B).
Polyadipate (adipic acid with 1,3-butanediol, 1,2-propanediol and 2-ethyl-1-hexanol) has a major effect on sliding force for PBAT and PBSA, i.e. the 2 copolyesters with adipic acid and butanediol as co-monomers (compounds D, E, F).
Compound D (formulated on PBAT and with 8% polyadipate of interest) has excellent functional properties for use in biodegradable stretch film, far superior to Novamont's commercial control (Master-bi brand CX 01A).
The sliding force value of compound D film is fully comparable to market standards for PE (polyethylene) or PVC (polyvinyl chloride) films.

Other tests have also shown that similar effects can be observed using 1% or 2% Glyplast 206, or a quantity of up to 20%. Without wishing to be bound by this theory, it is assumed that polyadipate behaves as a plasticizing agent. It is assumed that this effect can be optimized by using a polyadipate whose chain length of the diol(s) is less than or equal to the chain length of the diol(s) of the high-molecular-weight polymer, with a factor of 10, 20 or more between the molecular weights by weight of the polyadipate (acting as plasticizer) and those of the high-molecular-weight polymer.

### Example 2. Product Characterization

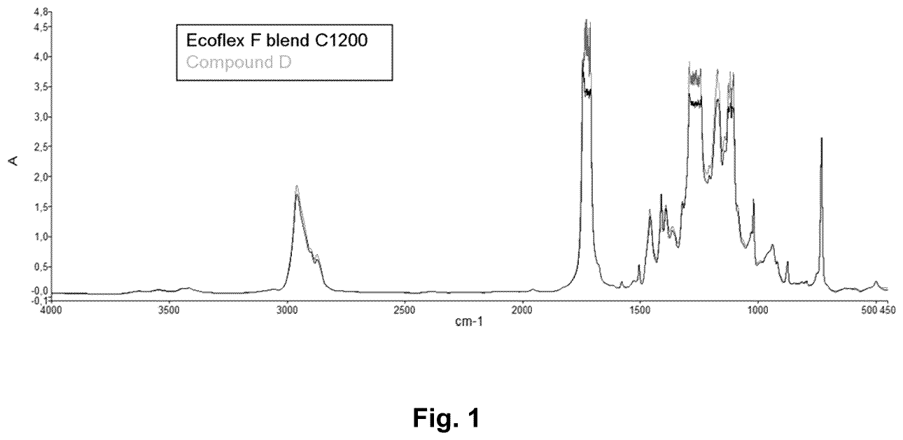

The FTIR (Fourier Transform Infra-Red) spectra of Ecoflex F C1200 and compound D, i.e. including 8% of the polyadipate of interest, are extremely similar (over 99.5%): no specific detection of polyadipate (see FIG. 1).

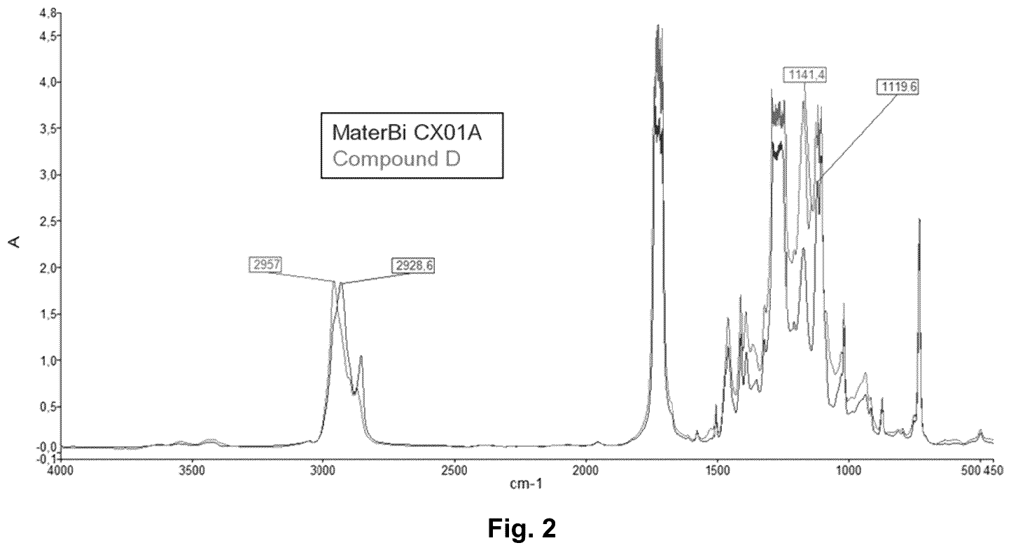

Compound D is significantly different from MaterBi CX01A, particularly in terms of its carbon chain (CH3 and CH2; peaks around 2950 cm-1) (see FIG. 2).

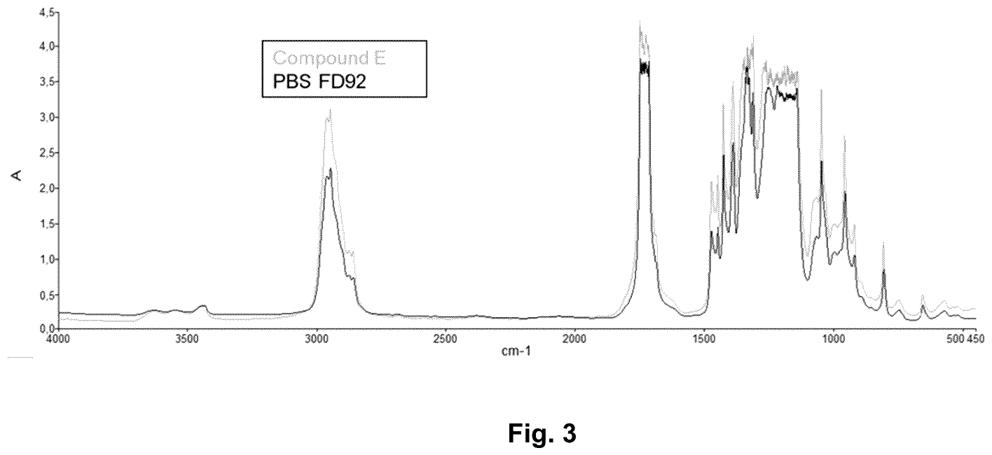

On the PBS FD92 polymer (polybutylene-co-adipateco-succinate), the FTIR spectra are also very similar at over 99.3% (see FIG. 3).

It can therefore be seen that the addition of the polyadipate of interest does not alter the structure of the final polymers (compared to the structure of high molecular weight polymers), which could mean excellent integration of this polyadipate.

### Example 3. Biodegradation Characteristics

Generally speaking, polyadipates are considered to have good biodegradability. Good biodegradability of the final product is therefore expected when the polyadipate of interest is introduced into a polymer matrix that is itself biodegradable.

Comparative biodegradation kinetics were verified.

The measuring system used (WTW Oxitop® equipment) is designed to quantitatively monitor the pressure drop within a closed system. The pressure drop measured is linked to the mineralization process: when oxygen is consumed by microorganisms, this is associated with a release of carbon dioxide, which is immediately trapped by caustic soda (NaOH), thus causing a pressure drop within the system. This pressure drop is correlated to oxygen consumption by means of the law of perfect gases, which in turn is translated into carbon dioxide production by means of the relationship defined by the respiratory coefficient (QR), so that test results can be expressed as a percentage of carbon degradation.

The test reactors are placed in a thermostatically-controlled chamber to control the test temperature. Each reactor is gently and continuously stirred by a magnetic stirrer to obtain a homogeneous medium within the reactor, and to allow aeration of the liquid phase. It should be noted, however, that this form of aeration does not allow optimum oxygen transfer between the gaseous phase and the aqueous medium, as this oxygen transfer may in some cases become a limiting factor and thus control the rate of degradation.

The test medium used for the biodegradation test is that recommended by ISO 14852; inoculum and samples are also prepared in accordance with this reference. As these are biodegradability tests involving natural processes, each of the biodegradability tests was carried out in triplicate in order to check the robustness and reproducibility of the tests. A negative control with no additional carbon source was used to assess the natural respiration of the inoculum. A positive control with a carbon substrate such as microcrystalline cellulose was also performed.

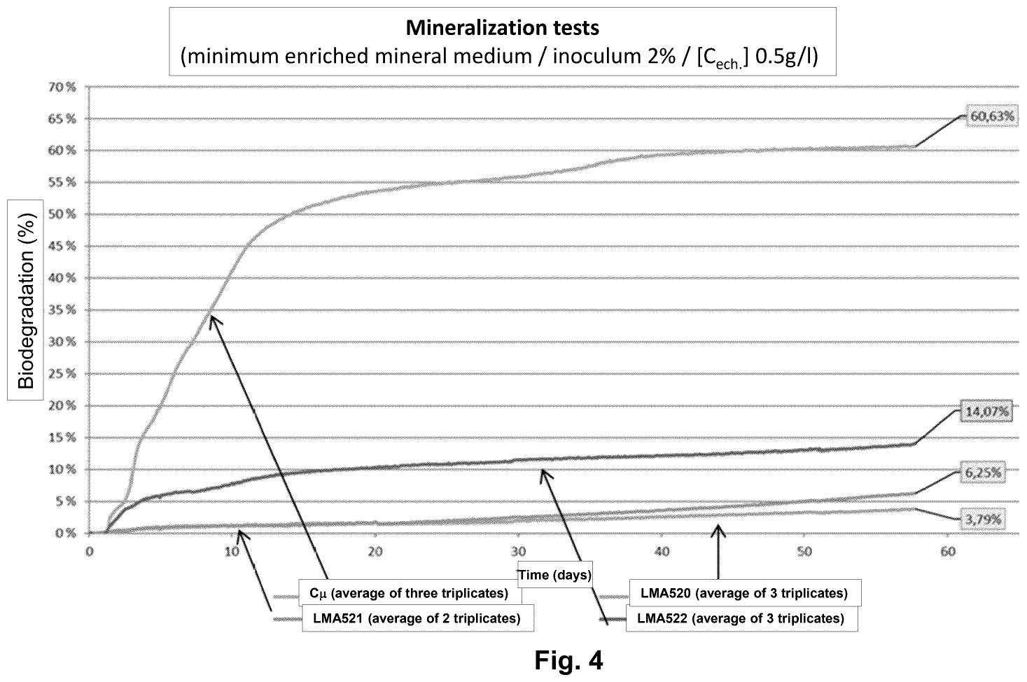

Tests were carried out at a temperature of 40+/−2° C. and mineralization was monitored for around 60 days. Biodegradation of the invented material was more than 2 times faster than the MaterBi CX01A commercial control and 4 times faster than the Ecoflex F C1200 base polymer (FIG. 4).

It is assumed that one of the reasons for this improvement is the reduced hydrophobicity of the compound D film. This property was measured by the contact angle.

We found: Ecoflex C1200: 88.7°. Compound D: 65.8

By adding the polyadipate of interest, the reduction in the contact angle of Ecoflex F C1200 from 89° to 66° improves water affinity and bacterial biofilm formation, resulting in accelerated biodegradation. This phenomenon is also characterized by very short lag times, visible from the very first days, as the film from compound D follows biodegradation kinetics similar to those of cellulose.

In conclusion,

The technical elements of innovation:
It is possible to intimately incorporate a polyadipate formed by esterification of adipic acid with C-3 or C4 diols or mixtures thereof (in particular 1,3-butanediol or 1,2-propanediol (optionally in the presence of 2-ethyl-1-hexanol) into a high molecular weight aliphatic copolyester and/or aliphatic-aromatic copolyester.
The polyadipate introduced between 1 and 20% w/w into the copolyester enables the production of biodegradable or compostable stretch films with high sliding force values, comparable to traditional polymers (PE or PVC) which are not very biodegradable or compostable.
Polyadipate increases polymer biodegradation kinetics, most likely by reducing polymer hydrophobicity
Polyadipatese acts as a plasticizer for copolyesters of the PBAT and PBSA types: DSC (differential scanning calorimetry) analyses show a 5° C. shift in Tg (glass transition from −36.2° C. to −40.8° C. on Eco F C1200), which is considered significant; given the excellent chemical compatibility between polyadipate and high-molecular-weight polymers (PBAT and PBSA), notably through the adaptation of diol chain lengths, deplasticization is highly unlikely, which means that film properties are likely to be stable over time.

### Example 4. Measurement Protocols

### 1. Mechanical Properties

The characterizations are carried out, for example, on a Lloyd tensile testing machine equipped with a 100 N load cell.

a. Tensile Tests at Break

Film specimens are cut according to ISO 527-3, specimen type 2; as the materials are anisotropic, the direction of extrusion (long direction-SL or machine direction SM) and the cross direction to extrusion (ST) must be identified. The tensile fracture test is a destructive test performed at room temperature 20° C., which consists in imposing an increasing deformation at constant speed (100 mm/min, according to ISO 527-1) and measuring the force required to impose this deformation. Recorded parameters include:
Young's modulus (MPa) or modulus of elasticity (longitudinal) or tensile modulus is the constant that links tensile stress and the onset of deformation in an isotropic elastic material (Hooke's law).
Maximum strength (MPa): maximum load reached during the tensile test
Breaking strength (MPa): load measured at the moment of sample breakage.
Maximum elongation (%): ratio between the sample size reached at breaking strength and its initial size before deformation.
   b. Slip or Sliding Tests

The tensile testing machine is equipped with a horizontal plane on which the film sample is mounted. A sled (200 g, 25 mm wide) is connected to the machine's force transducer; sled speed is 100 mm/min according to ASTM D1894 or ISO 8295. Samples are at least 80×250 mm in size (the larger dimension corresponding to the direction of measurement, SL or ST). The sled can also be covered with the film under consideration, in which case the slip measurement is called film/film (otherwise, metal/film).

The recorded parameters include:
The coefficient of static friction, being the ratio between the static friction force and the pressure force of the sled.
The dynamic friction coefficient, being the ratio between the dynamic friction force during movement and the pressure force of the sled.

In particular, the force required (N) to pull the sled is measured.

### 2. Viscosity Measurement of Polyadipate Ester

The method used is based on the ISO 2555 standard for determining the Brookfield apparent viscosity of resins in the liquid state or similar, using one of the types of rotational viscometers described in the standard.

A cylindrical or related mobile (disk) rotates at a constant frequency around its axis in the product under examination. The resistance exerted by the fluid on the mobile, which depends on the product's viscosity, causes a torsion which is measured on a suitable measuring device. The apparent viscosity according to the Brookfield method is calculated by multiplying this measurement by a coefficient dependent on the rotation frequency and the characteristics of the mobile.

### 3. Molar Mass Measurement of Polymers

Steric exclusion chromatography (SEC) is used to obtain the number-average molar mass Mn, and the weight-average molar mass Mw, with a sample dissolved in chloroform. The SEC results are evaluated on the basis of the IR detector, with conventional PS (polystyrene) calibration.

### 4. Thermal Analysis by DSC

Differential Scanning calorimetry (DSC) provides information on the thermal transitions of a polymer (glass transition, melting, crystallization, etc.). It involves applying a temperature program to the sample and measuring the temperature difference between the sample in its crucible and an empty crucible used as a reference. Appropriate calibration of the instrument enables this temperature difference to be converted into heat flux (in mW/mg), providing quantitative information on the polymer's thermal transitions (deduction of the degree of crystallinity, etc.).

Analyses are performed on a Mettler Toledo DSC1 instrument with a program whose segments are as follows:
−50° C. to 250° C. at +10K/min under N₂ gas
250° C. to −50° C. at −10K/min under N₂ gas
−50° C. to 250° C. at +10K/min under N₂ gas

### 5. FTIR Spectrometric Analysis

FTIR (Fourier Transform Infrared) spectrometry records the characteristic spectrum of the material being analyzed. This spectrum comprises a set of absorption bands whose position (wave number) and intensity are specific to each molecule (or mixture). Its interpretation can be used to identify chemical groups present in the material. FTIR spectra can be recorded using different analysis modes, depending on the nature and dimensions of the sample (films, microparticles, etc.). The ATR-germanium mode records an FTIR spectrum of the extreme surface of a sample. The depth analyzed is typically less than 3 1.1m, which is particularly useful in the case of highly IR-absorbing black films, or in the case of thin multilayer films.

### 6. Biodegradability Measurement

Characterization of the biodegradability of packaging materials for use in industrial composting is governed by EN 13432, which is based on standardized protocols described in ISO 14851, ISO 14852 and ISO 14855. We applied a simplified methodology for analyzing the biodegradability of plastics (simplified Sturm test), based on monitoring oxygen consumption by continuous pressure meter analysis within a closed reactor; this measurement can then be correlated with the amount of carbon dioxide produced via the Respiratory Quotient (Qr), which is around 0.7 for most microbial metabolisms.

The measuring system used (WTW Oxitop® equipment) is designed to quantitatively monitor the pressure drop within a closed system. The pressure drop measured is linked to the mineralization process: when oxygen is consumed by microorganisms, this is associated with a release of carbon dioxide, which is immediately trapped by caustic soda (NaOH), thus causing a pressure drop within the system. This pressure drop is correlated to oxygen consumption by means of the law of perfect gases, which in turn is translated into carbon dioxide production by means of the relationship defined by the respiratory coefficient (QR), enabling test results to be expressed as a percentage of carbon degradation.

The test reactors are placed in a thermostatically-controlled chamber to control the test temperature. Each reactor is gently and continuously stirred by a magnetic stirrer to obtain a homogeneous medium within the reactor, and to allow aeration of the liquid phase. This form of aeration does not allow optimum oxygen transfer between the gaseous phase and the aqueous medium, as oxygen transfer can in some cases become a limiting factor and thus control the rate of degradation.

This method enables the rapid, reliable analysis of numerous products in parallel, the most interesting of which can then be subjected to the standardized protocol.

1. A plastic film containing a layer comprising an aliphatic copolyester and/or an aliphatic-aromatic copolyester and between 1 and 20% (by weight) of a polyadipate consisting of a polyester of adipic acid with a C3-C4 diol or diol mixture.

2. The plastic film of claim 1, wherein the molecular weight of the aliphatic-aromatic copolyester is greater than or equal to 30,000 g/mol.

3. The plastic film of claim 1, wherein the layer contains between 5 and 12% of polyadipate.

4. The plastic film of claim 1, wherein the viscosity of the polyadipate is between 800 and 1200 cPoise at 25° C.

5. The plastic film of claim 1, wherein the polyadipate has a molar mass of less than 5000 g/mol.

6. The plastic film of claim 1, wherein the diol of the polyadipate is selected from 1,3-butanediol, 1,2-propanediol, and mixtures thereof.

7. The plastic film of claim 1, wherein the diol or diol mixture also contains 2-ethyl-1-hexanol.

8. The plastic film of claim 1 having:
a slip force (film/film, N/25 mm) greater than or equal to 3;
a Young's modulus greater than or equal to 80 MPa; and/or
an elongation at break in the extrusion direction greater than or equal to 500%.

9. (canceled)

10. (canceled)

11. The plastic film of claim 1, wherein the aliphatic-aromatic copolyester is a poly(butylene terephthalate-co-adipate) (PBAT).

12. The plastic film of claim 1, wherein the aliphatic copolyester is a polybutylene succinate-co-adipate (PBSA).

13. The plastic film of claim 1, additionally containing at least one further component selected from UV stabilizers, colorants, antioxidants, brighteners, and anti-fogging agents.

14. The plastic film of claim 1 having a thickness between 5 μm and 80 μm.

15. The plastic film of claim 1, wherein the plastic film it is single-layer.

16. The plastic film of claim 1, wherein the plastic film is multilayer, the layer containing the aliphatic copolyester and/or aliphatic-aromatic copolyester and between 1 and 20% (by weight) of the polyadipate consisting of a polyester of adipic acid with a C3-C4 diol or diol mixture being an outer layer.

17. The plastic film of claim 1 obtained by blow extrusion or flat extrusion.

18. A method of manufacturing the plastic film of claim 1 comprising:
(a) obtaining a mixed material by mixing in an extruder:
(i) an aliphatic copolyester and/or an aliphatic-aromatic copolyester,
(ii) between 1 and 20% (by weight) of a polyadipate consisting of a polyester of adipic acid with a C3-C4 diol or diol mixture, and
(iii) optionally, at least one other component selected from anti-UV agents, colorants, antioxidants, brightening agents, and anti-fogging agents; and
(b) forming a film from the mixed material by extrusion blow-molding or flat extrusion.

19. A method for wrapping a pallet, packaging food, or packaging and protecting an agricultural product comprising wrapping the pallet, packaging the food, or packaging and protecting the agricultural product with the plastic film of claim 1.

20. (canceled)

21. The method of claim 18, wherein the film has a slip force (film/film, N/25 mm) greater than or equal to 3.

22. A process for preparing a material suitable for manufacture of a plastic film comprising:
(a) mixing in an extruder:
(i) an aliphatic copolyester and/or an aliphatic-aromatic copolyester,
(ii) between 1 and 20% (by weight) of a polyadipate consisting of a polyester of adipic acid with a C3-C4 diol or diol mixture, and
(iii) optionally, at least one other component selected from anti-UV agents, colorants, antioxidants, brightening agents, and anti-fogging agents; and
(b) obtaining a material suitable for manufacture of the plastic film.

23. A material obtainable by the process of claim 22.
